(19) United States
(12) Patent Application Publication
(10) Pub. No.: US 2021/0350359 A1
(43) Pub. Date: Nov. 11, 2021

(54) SYSTEM AND METHOD FOR TRANSFERRING A DIGITAL REPRESENTATION OF REAL FUNDS

(71) Applicant: Kenneth J. Silverman, Southampton, NY (US)

(72) Inventor: Kenneth J. Silverman, Southampton, NY (US)

(21) Appl. No.: 17/384,472

(22) Filed: Jul. 23, 2021

Related U.S. Application Data
(63) Continuation-in-part of application No. 16/289,410, filed on Feb. 28, 2019.
(60) Provisional application No. 62/637,648, filed on Mar. 2, 2018.

(51) Int. Cl. G06Q 20/36; H04L 9/32; G06Q 20/06; G06F 16/27

(52) U.S. Cl. CPC G06Q 20/3678; H04L 9/3236; G06Q 20/065; G06Q 2220/10; H04L 2209/38; H04L 2209/56; G06F 16/27

(57) ABSTRACT

A system configured to provide a customer with a digital representation of an amount of real funds for the subsequent transfer thereof to third-parties may comprise a fiat ledger system and a distributed ledger system disposed in connection through a bridging system, such bridging system configured to circulate digital tokens therefor, and redeem such digital tokens for the ultimate end-user thereof, while holding such amount of funds within a financial institution's reserve account. Consequently, such a bridging system may comprise a bridging component configured to equivocate between the fiat ledger system and the distributed ledger system by effectuating a series of ledger entries on each such system. Such a system may comprise yet additional components configured to merge disparate financial entities having distinct sets of digital tokens into a unitary version thereof, and effectuate exchanges between other third-party financial entities utilizing, for instance, digital tokens formed under a foreign currency.

### CLAIM OF PRIORITY

The present application is a continuation-in-part application and claims priority under 35 U.S.C. § 120 to a currently pending U.S. patent application having Ser. No. 16/289,410 and a filing date of Feb. 28, 2019, which itself claims priority to a previously filed provisional patent application having Ser. No. 62/637,648 and a filing date of Mar. 2, 2018, each of which is incorporated by reference herein in its entirety.

### BACKGROUND OF THE INVENTION

### Field of the Invention

At least one embodiment of the present invention comprises systems and methods configured to enable a financial institution to issue a digital representation of an amount of real funds to a customer, for the subsequent transfer thereof to interested third-parties, while retaining such amount of funds within the financial institution's reserve account until an end-holder of digital representation requests redemption thereof.

### Description of the Related Art

Currently, the electronic transfer of FIAT currency may occur through two different systems. One such system is a standard bank transfer, whether bank-to-bank or otherwise, which may occur in slightly different variations dependent upon the relationship between the bank and the customer. Such relationships include, without limitation, a debit account, a line of credit account, and a credit card account. Alternatively, FIAT currency may be transferred electronically through a stablecoin transfer, whether comprising a transfer from an exchange, or stablecoin marketplace, to an electronic wallet, or a transfer from an electronic wallet to a different electronic wallet. Each of these systems will be discussed in greater detail hereafter.

In traditional banking systems, the value stored in a debit account, provided to a customer via a line of credit, or otherwise made available to a customer through a credit card account represents a promise between the bank and the customer. As such, the relationship between the bank and the customer may be construed as that of promisor-promisee, wherein the bank is the promisor and the customer is the promisee. As such, it may be understood the bank, in taking on the role of promisor, necessarily owes an obligation to the customer, the promisee. As will be discussed hereafter, such obligation depends upon the value at issue within a given promise, which may differ dependent upon the context in which the promise is made.

For instance, when a customer opens a debit account with a bank, the value stored in such bank account comprises the promissory value at issue in the aforementioned obligation between the bank and the customer. More specifically, the value stored in the bank represents the obligation of the bank to pay any portion of that value upon the customer's demand. Because the amount of funds disposed within a customer's debit account are the customer's own funds, it may be understood the debit account represents one of the simplest forms of a promissory relationship between a bank and its customer.

Similar to a debit account, a line of credit account between a customer and bank also creates an obligation dependent upon the value of funds disposed within such line of credit account. However, because the funds disposed within a line of credit account are borrowed by the customer, instead of owned thereby, it may be understood such funds represent a sort of pre-promise, wherein the terms of repayment by the customer are described thereby. Generally speaking, the promise stemming from a line of credit account may be considered as created at the time of demand. In conjunction therewith, such promise may be considered as represented when the funds at issue are transferred from the bank's account, whether comprising a reserve account or otherwise, to the customer's credit account. Accordingly, it may be understood a second promise is created when such funds are used, such as at the time of demand, as now the aforementioned pre-promise represented by the funds now becomes a secondary promise of the customer to repay such funds to the bank, according to certain predefined conditions. Once such repayment is effectuated by the customer, it may be understood the secondary promise is fulfilled, and is therefore nullified and/or destroyed. One other common context in which a promise is made between a bank and a customer comprises a credit card account. As may be understood, a credit card account between a bank and a customer operators similar to a line of credit account, as the funds subject of such credit card account are promised by the bank to be deliverable upon the customer's demand. In other words, the bank in a credit card account promises to deliver funds upon the customer's transaction with a third-party entity. However, a credit card account differs from a line of credit account because the bank's promise is not to transfer funds to the customer itself, but rather, to transfer the pertinent funds to such third-party entity.

In conjunction therewith, it may be understood the bank, upon receiving demand from a customer having a credit card account via a transaction executed by such customer, will transfer funds from one of its accounts, whether comprising a reserve account or otherwise, to the applicable third-party entity. Such transfer of funds may occur directly, or may occur indirectly, wherein such funds will first travel through one or more intermediary banks. In such indirect transfers, it may be understood a series of promises may thus be created and nullified and/or destroyed, as each intermediary bank makes a promise to transfer the applicable funds to the next receiving party, whether another intermediary bank, the pertinent third-party entity, or otherwise.

Once such transfer of funds is effectuated to the pertinent third-party entity, it may be understood the bank's obligations are thus fulfilled, and its promise is thus nullified and/or destroyed. However, akin to the line of credit example discussed above, the customer, upon making demand via the execution of a transaction, now has a secondary promise to repay that amount of funds to the bank, under certain predefined conditions. Once again, once repayment of such funds is made, such secondary promise is fulfilled, and therefore nullified and/or destroyed.

As may be seen, each of the foregoing instances of a promisor-promisee relationship between a bank and a customer ultimately involves some type of transfer of funds. In the case of a debit account, funds are transferred from the customer to the customer's account with the bank. In the instances of a line of credit account and credit card account, however, the bank transfer funds from its own account, whether a reserve account or otherwise, to the applicable party, whether comprising the customer's account, such as in a line of credit account, or comprising a third-party entity, such as in a credit card account. As a result of such actual transfer of funds, certain problems and/or issues exist in such systems, as will be discussed in greater detail hereafter.

Stablecoin systems, on the other hand, transfer value in response to a customer's actions, which may comprise infusing the exchange with funds to purchase a stablecoin, or in response to a trade effectuated through such an exchange. In this sense, it may be understood such a value transfer may only occur upon the customer's initiative, wherein an initiating action, such as the purchase, sale, or trade of an online exchange or marketplace initiates such a value transfer. As a result, however, stablecoin systems require such customer initiative to occur on the relevant exchange and/or online marketplace and, thus, require a customer to interact with such exchange and/or marketplace. As such, a stablecoin system may not electronically transfer value in direct response to a customer's interaction with a bank, whether comprising the withdrawal of funds from a debit account, the demand of funds through a line of credit account, the execution of a transaction through a credit card account, or otherwise. In this manner, it may be understood existing stablecoin systems are distinct from the aforementioned banking systems, and require user interaction and actual funds to be transferred to the applicable exchange and/or online marketplace for the operation thereof. Accordingly, much like the type of banking transfers previously discussed, stablecoin systems also require a transfer of funds to effectuate the electronic transfer of funds because the customer must first move funds from a financial institution and place such funds onto the pertinent exchange to purchase a stablecoin or other like digital currency.

As already discussed, each of the foregoing systems requires some transfer of funds to effectuate an electronic transfer thereof. As may be understood, such actual transfer of funds can be problematic, or otherwise restrictive, for either the customer, the bank, or any other pertinent third parties. For instance, in the case of banking transfers, the transfer of actual funds to a user's account, such as in a line of credit account, results in a deficit, or hold, in the bank's accounts, such as in their reserve account. In other words, because the bank in a line of credit account is required to place certain funds into a customer's account, the bank no longer has access to those funds until the customer has completed their promise to repay such funds. As a result, those funds are effectively held in abeyance until such completion of the customer's promise, meaning the bank cannot utilize those funds for other purposes, such as for providing loans to other customers. Alternatively, in the case of stablecoin networks, it may be understood the actual transfer of funds into an exchange or online marketplace means the customer likewise does not have access to such funds, nor does the bank with whom the customer may have been holding funds in a debit account in the first place. Once again, it may be understood this transfer of real funds may impact the relevant parties, whether restricting the user's access to such funds, preventing the bank from using such funds to provide loans to other customers, or otherwise.

Yet, this is not the only problem stemming from such banking and stablecoin systems. For example, when banking systems execute their promise for the customer of a credit card account in a credit card transaction, the result of the already discussed use of intermediary banks, and the resultant creation and destruction of promises which stem therefrom, is the requisite use of financial clearing houses.

Such clearing houses operate to facilitate the exchange of funds and settle, or otherwise authorize, such exchanges through a centralized and standardized organization. As such, clearing houses stand to reduce operational risk in instances such as this, where a plurality of parties are engaging in a plurality of promises to effectuate the exchange of funds. But clearing houses also restrict the bank's use of funds by, for instance, setting initial margin requirements to ensure the bank can actually perform the trade. In other words, clearing houses commonly hold funds in abeyance, thereby restricting the initial promisor, the customer's bank, from completing its promise. Likewise, the ultimate promisee of a credit card transaction, the pertinent third-party, may not receive the funds until the clearing house completes their operations. As such, clearing houses reduce efficiency in the electronic transfer of funds.

Even further, the foregoing systems typically result in a litany of promises between a plurality of different parties. Consider, for instance, a credit card transaction. There, the first promise created comprises the promise between the bank, the initial promisor, and the customer holding the credit card account, the initial promisee. Then, when the initial promisee effectuates a credit card transaction, whether via swiping their card at a kiosk, through an online credit card transaction, or otherwise, and thereby makes demand of the initial promisor, a second promise is created. This second promise is between the initial promisor, the bank, and the secondary promisee, the third-party, such as a merchant. Once the initial promisor effectuates the transfer of funds to the secondary promisee, the initial promise and the secondary promise are both destroyed, as the obligations for each such promise is thus fulfilled. However, a tertiary promise is now formed to replace the initial promise, wherein such tertiary promise comprises a promise made by the initial promisee, the customer, to repay the amount of funds at issue in such transaction to the initial promisor, the bank. As may be understood, the foregoing example omits the plurality of intervening promises which may occur due to the possible use of intermediary banks when the initial promisor, the bank, effectuates the transfer of funds to the secondary promisee, the third-party, which could expand the number of promises created in a single transaction even further.

As may be understood, at least some of the foregoing problems may be resolved through the provision of self-custodial digital currencies to users. However, because current systems require users to actually transfer real funds in order to acquire digital currencies, whether comprising a cryptocurrency, stablecoin, or otherwise, it may be understood the provision of such digital currencies to users currently suffers from its own inadequacies, namely, the inability of users, or a bank, to be in control of the real funds. In totality, the foregoing problems stem from an inability to link, or otherwise bridge, between various fiat-based and cryptocurrency-based accounts and/or ledgers without the need to effectuate the actual transfer of real funds to the pertinent third-parties, whether comprising a merchant, a stablecoin and/or cryptocurrency exchange, or otherwise. Alternatively put, because current systems do not allow for such bridging of accounts and/or ledgers, users are currently exposed to the worst problems of each such system.

In view of the foregoing, there exists a need for a system designed to electronically transfer funds without the need to transfer real funds, use clearinghouse operations, or create a litany of promises for a given transaction. Such a system should be designed to more effectively, and more efficiently, electronically transfer funds through each of the types of banking operations a customer may require. Moreover, such a system should be designed to allow for a single promise to be transferred an unlimited amount of times. Even further, such a system should be designed such that it may allow for the effective transfer of electronic funds between banking systems or users based in different currencies. Likewise, such a system should provide a mechanism whereby different banking systems, countries, nations, or sovereignties using distinct electronic currencies may be able to merge such distinct electronic currencies into one, singular electronic currency. Finally, such a system should be configured to effectuate a reduction in fees from those already associated with present systems configured for credit card transactions and the like, wherein the mere act of credit card transaction, and the necessity of clearinghouse operations which stems therefrom, necessitates a certain amount of fees to be charged therefor.

### SUMMARY OF THE INVENTION

The present invention presents solutions to the foregoing problems through a system and method for electronically transferring a digital representation of a given amount of real funds, whereby such system and method may be provided through a convenient electronic platform, such as a mobile application or application programming interface. Generally speaking, such a system and method are designed for the creation of an electronic and/or digital representation of a promise, such as a promissory note, a debit account, a line of credit account, a credit card account, or any other type of promissory and/or trust-based relationship between parties, whether now known or hereafter developed. Even further, such a system and method is designed to allow a bank to mint, issue, or otherwise transfer digital tokens, which comprise such electronic and/or digital representation of a promise, to their customers for the subsequent transfer thereof to any interested third parties, ad infinitum.

Generally speaking, the system of at least one embodiment of the present invention may comprise a fiat ledger system and a distributed ledger system, with a bridging system disposed in connection there between. Even further, such a bridging system may further be disposed in connection with an interface component, configured to display information to users, whilst providing input-output operations whereby users may control the various functionalities of the bridging system. Such an interface component may comprise, for instance, a graphic user interface disposed on a user's digital device, such as a computer, laptop, smartphone, tablet, or any other device configured to communicate with other devices over a peer-to-peer network, such as a kiosk or automated teller machine, whether now known or hereafter developed.

As previously stated, at least one embodiment of the present invention may comprise a fiat ledger system. Such a fiat ledger system may comprise, for instance, the various ledgers used in a traditional banking system, and may thus include at least one, and in many instances a plurality of customer accounts, as well as the general reserve account of the pertinent financial institution. Such a financial institution may comprise, for instance, a bank, any other entity with an internal electronic ledger of accounts, or any entity having a special relationship with an existing bank wherein such entity controls the outflows of monies from accounts under its control that pertain to its customers, such as a credit card company. As understood by those skilled in the art, the general reserve account of a given financial institution may comprise, for instance, a liquid account into which a bank or some other financial institution places deposits sufficient to fulfill the withdraw requests issued by its customers. Further, such a fiat ledger system may additionally comprise a redemption account. Such a redemption may comprise, for instance, the same account as the aforementioned customer account, or may alternatively comprise a bank account for a third-party. As may be understood, such a third-party bank account may be disposed at the same financial institution, or at an alternative financial institution.

Further, at least one embodiment of the present invention may comprise a distributed ledger system, which consists of a ledger both distinct and separate from the aforementioned fiat ledger system of any given financial institution. Rather, such a distributed ledger system may comprise, for instance, a blockchain, a decentralized acyclic graph, a tangle, or some other permissioned or permission-less cryptocurrency network, whether private or public, and whether now known or hereafter developed. Such a distributed ledger system may further comprise, for instance, a user hot wallet, which may be understood as comprising a tool which may allow a user of the present invention to receive and send digital tokens, and which may be governed by a smart contract in at least one embodiment of the present invention. Such a user hot wallet may be linked with various public and private keys to facilitate transactions and provide security. Even further, it should be noted such a hot wallet may either be connected to the internet, or may instead be disposed in an offline environment, provided such hot wallet may later be provided internet connectivity, whether through a different wallet address or otherwise. Additionally, such a distributed ledger system may also comprise at least one third-party wallet, and in most embodiments a plurality of third-party hot wallets, which may be understood as equivalent to the foregoing user hot wallet, but simply managed by a third-party as opposed to the user of the system of the present invention.

As previously stated, the foregoing fiat ledger system and distributed ledger system may be disposed in connection via a bridging system disposed there between. Generally speaking, such a bridging system may act as a link between the fiat ledger system and the distributed ledger system, such that the foregoing functionalities of providing users with a system configured for the electronic representation of real funds and the subsequent transmittal thereof to third parties, ad infinitum, may be realized. Alternatively put, such a bridging system may comprise various components configured to mint and/or provide digital token(s) for an amount of funds represented by a promise between a user of the system and his or her pertinent financial institution, provide various funds transfers and redemption and/or fulfillment capabilities for the end-holder of the digital token(s), as well as ensuring such fiat ledger system and such distributed ledger system remain in balance across the totality of transactions and/or promises entered into between pertinent financial institutions and their plurality of customers. Even further, the bridging system of additional embodiments of the present invention may further provide for various additional functionalities, such as the transfer of electronic funds between users based in different currencies and/or the merging of financial institutions utilizing disparate electronic currencies into a single, all-encompassing electronic currency.

For instance, at least one embodiment of the bridging system of the present invention may comprise: (1) a minting component; (2) a relocation component; (3) a fulfillment component; and (4) a bridging component. Even further, additional embodiments of the bridging system of the present invention may additionally comprise: (5) a transfer component; and (6) a merging component. Each of the foregoing components will be discussed in greater detail hereafter.

The minting component of at least one embodiment of the present invention may be configured to effectuate the transformation of a given amount of real funds represented by a promise, whether through a debit card account, a credit card account, a line of credit account, or otherwise, or alternatively some other type of value deemed acceptable by the financial institution to represent the real funds, into an electronic representation of such given amount of real funds, such as a digital token. Although referred to as the “minting component” herein, it should be understood the minting component of the present invention is not limited only to instances wherein the financial institution itself mints, or otherwise creates, a new digital token upon the formation of a promise between a user and the financial institution itself. Rather, such minting component of alternative embodiments of the present invention may instead be configured to allow a financial institution to merely provide a user with an already existing digital token, such as one already minted by a governmental authority, such as the United States Securities and Exchange Commission, or alternatively some other financial institution.

Alternatively, such a minting component may instead be configured to utilize already existing digital tokens minted by the pertinent financial institution, or otherwise minted by any other third-party, such as an alternative financial institution, a third-party exchange, a digital marketplace, or otherwise. As such, it may be understood the digital token(s) of the present invention may be federally-backed, central-bank backed, and/or central-bank generated and minted. Whatever the source of origin, such digital tokens may, in certain embodiments, be configured to be ERC-20 compliant, such that such digital tokens comply with officially regulated standards. Alternatively, it may be understood such digital tokens may instead be configured to comply with any other standard, whether now known or hereafter developed. Further, it may be understood such digital token(s) may be divisible, separable, and comprise any positive and real integer. Accordingly, such digital tokens may be configured to be accepted by a certain financial institution, even if such financial institution did not mint or otherwise generate such digital tokens itself. Likewise, such digital tokens may be sourced in and/or from an existing promissory and/or trust-based relationship, whether with the same customer as the present relationship, or some other relationship between the financial institution and a third-party.

Simply put, regardless of the source of minting, the digital token(s) of the present invention may be understood as representative of the link of a promise between the promisor, namely the pertinent financial institution, and the promisee, namely the user. For instance, a minting component in accordance with at least one embodiment of the present invention may be utilized to represent a promise borne out of a debit account between a customer and the pertinent financial institution. In such instance, it may be understood the digital token(s) provided to the customer for such a debit account may represent those real funds already stored within the customer's debit account. In instances pertaining to a credit card account, it may be understood the digital token(s) represent the amount at issue in a given transaction. A digital token representing a line-of-credit account may be understood as at least somewhat akin to the foregoing example for a credit card account in the sense that the funds represented by such digital token were not in the possession of the customer at the time the promissory and/or trust-based relationship was formed.

Accordingly, it may be understood once a given promise is effectuated between a user and a pertinent financial institution, the minting component may, either automatically or at the behest of the user, as may be required in instances wherein the digital token(s) are minted by a federal institution, proceed to mint or otherwise issue such digital token(s) to the user by effectuating a transaction on the distributed ledger system to place such digital token(s) with the user hot wallet. As such, the result of the minting component is the provision of a certain amount of digital token(s), representing the real funds subject to a promise, within the user hot wallet. As such, once such digital token(s) are provided to the user hot wallet, it may be understood such digital token(s) are freely accessible and transferrable by the user.

With the foregoing minting component in mind, the relocation component of at least one embodiment of the present invention may be understood as a means for maintaining equilibrium between the fiat ledger system and the distributed ledger system. In other words, because the pertinent financial institution is providing an electronic representation of real funds to a consumer via the minting component, it may be understood the fiat ledger system and the distributed ledger system will be out of balance once such digital token(s) are provided to the user hot wallet. As such, the relocation component of at least one embodiment of the present invention operates to relocate the real funds that are the subject of the pertinent promise to the reserve account of the fiat ledger system. In so doing, it may be understood the financial institution is, at least temporarily, in control of such real funds until the digital token(s) provided to the user are redeemed, whether by the user herself or by some other third party.

As such, the relocation of at least one embodiment of the present invention may be understood as providing the promisor, namely the pertinent financial institution, with a role as a trustee having a fiduciary responsibility to preserve the assets of such real funds. As such, because such real funds are disposed within the reserve account of the financial institution, it may be understood the financial institution must be ready to fulfill their original promise once fulfillment is requested by the holder of the already minted and provided digital token(s).

Accordingly, the foregoing arrangement of the real funds within the reserve account by the relocation component establishes a trustee-beneficiary relationship between the financial institution and the holder of the digital token(s). Alternatively put, because the real funds are disposed within the reserve account, such real funds are freely transferable to whomever holds the digital token(s) at the time of fulfillment. As such, the relocation component both balances the fiat ledger system and the distributed ledger system, while further providing for the free transfer of the beneficiary of the amount of real funds held in trust in the reserve account of the financial institution.

Moreover, because the real funds that are the subject of the promise are held in the reserve account of the financial institution, as opposed to at a clearinghouse, such as in a typical credit card transaction, or on a stablecoin exchange, such as in conventional stablecoin systems, it may be understood such real funds are neither held in abeyance at a clearinghouse nor at a stablecoin exchange. Rather, such real funds are freely accessible for the pertinent financial institution to utilize, provided such reserve account maintains a sufficient cash minimum to meet all fulfillment requests for its already circulated digital token(s). As such, once such real funds are transferred to the reserve account by the relocation component of at least one embodiment of the present invention, such real funds may be used by the financial institution for the purposes of, for instance, providing loans to other third parties. As such, the real funds of any given promise in the system of at least one embodiment of the present invention may therefore be used to maximize efficiency by providing continuous access to the funds by the financial institution while ensuring users may still utilize the electronic representation of such real funds via the aforementioned digital token(s).

Moving forward, and as previously stated, at least one embodiment of the bridging system of the present invention may additionally comprise a fulfillment component. Such a fulfillment component may be configured to allow the end-holder of the digital token(s) to redeem the real funds that are subject of the promise being represented by such digital token(s). As previously stated, because such real funds are currently held in the reserve account of the pertinent financial institution, the end-holder of such digital token(s) is the beneficiary of the now-signified trust arrangement of such real funds and, thus, may redeem such real value at any time of his or her choosing.

Accordingly, the fulfillment component of at least one embodiment of the present invention may be configured to perform at least three distinct steps. First, such a fulfillment component may receive a fulfillment or redemption request, or otherwise referred to as a demand, which constitutes a request by the beneficiary of the digital token(s) to receive the real funds subject to such digital token(s). Upon receipt of such a fulfillment request, the fulfillment component may, in connection with the aforementioned relocation component, transfer the pertinent amount of real funds represented by the digital token(s) to the redemption account. As previously stated, because the digital token(s) that were the subject of the original promise between the user and the pertinent financial institution are freely divisible and distributable, it may be understood all of the real funds originally represented by the digital token(s), or only a portion thereof, may be redeemed at a given time.

Once such applicable amount of real funds are transmitted to the redemption account, or otherwise in connection therewith, the fulfillment component of the present invention may then burn, destroy, extinguish, or otherwise temporarily render the digital token(s) at issue in such fulfillment request as unusable, such that such digital token(s) are no longer redeemable. Accordingly, it may be understood the fulfillment component of certain embodiments of the present invention may optionally choose to destroy the digital token(s), thereby deleting all electronic records associated with such digital token(s), absent those required to be maintained in the distributed ledger system, or, alternatively, simply add additional data to such records indicating such digital token(s) may no longer be redeemed or transferred. If such digital token(s) are not destroyed, but instead are merely rendered unusable, it may be understood such digital token(s) may then be held in abeyance in a digital token reserve for later use in connection with later-effectuated promises between the financial institutions and other users. Such digital token reserve may be interlinked with, for instance, an institution hot wallet disposed on the distributed ledger system, or a plurality thereof.

Further, in instances wherein the promise at issue includes promises made by the promisee, namely the user, to the promisor, namely the financial institution, such as in a credit card account wherein the promise made by the user is to repay the value of the original promise to the financial institution, the fulfillment component may further be configured to effectuate a nullification event. In such instance, it may be understood the fulfillment component may issue a repayment record within the pertinent customer account for the user that is the subject of such promise. Once such repayment is effectuated by such user, then the nullification event will be completed, and the records detailing such promise may then be destroyed or otherwise indicated as repaid.

Yet an additional embodiment of the bridging system of the present invention may further comprise a bridging component. Such a bridging component may be configured to balance the fiat ledger system and the distributed ledger system such that the total amount of value represented by the digital tokens provided to the users of a given financial institution, whether such digital tokens are minted by such financial institution or granted by such financial institution as federally minted and backed digital tokens, is equal to the total fiat disposed within the fiat ledger system. Alternatively put, the bridging component of the present invention may be configured to audit the foregoing processes of the bridging system, to ensure the fiat ledger system, and more particularly the reserve account, and the distributed ledger system are in equivalence.

In order to perform such balancing, the bridging component of at least one embodiment of the present invention may comprise a bridging algorithm designed to effectuate ledger entries on both the fiat ledger system and the distributed ledger system. As such, it may be understood such a bridging algorithm may itself comprise a set of rules and/or instructions pertaining to the manner in which ledger entries must be made upon, for instance, the creation of a promissory and/or trust relationship, the redemption of digital tokens, and thus the destruction of a certain promissory and/or trust-based relationship, and transfers of such arrangement, whether comprising a transfer of the promisee of such relationship, the beneficiary of such relationship, or otherwise. Simply put, such bridging algorithm, and by extension the bridging component as a whole, may be configured to bridge the entries disposed on both the fiat ledger system and the distributed ledger system via rules and/or logic, which may, in at least one embodiment, be stored in a cloud-based environment. Exemplary rules and logic, and thus, by extension, applications of such bridging component will be discussed in greater detail hereafter.

As previously stated, further embodiments of the bridging system of the present invention may comprise yet additional components, at least one of which may be configured to provide a communication link between the fiat ledger system and the distributed ledger system. For instance, such a bridging system may comprise a transfer component configured to enable users thereof to access his or her customer hot wallet to access the digital token(s) disposed therein, and subsequently transfer all of such digital token(s) to a third-party, or at least a portion thereof. In this sense, it may be understood any such transfer of digital token(s) may comprise effectuating a transfer from the user's customer hot wallet to a third-party hot wallet.

These and other objects, features, and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a block diagram depicting a system connecting a fiat ledger system and a distributed ledger system through a bridging system, wherein each such system is disposed in connection with an interface component, in accordance with at least one embodiment of the present invention;

FIG. 2 is a block diagram depicting the interconnection of a plurality of user devices and financial institutions in accordance with at least one embodiment of the present invention;

FIG. 3 is a block diagram depicting an interface component in accordance with at least one embodiment of the present invention;

FIG. 4A is a block diagram depicting a minting component in accordance with at least one embodiment of the present invention;

FIG. 4B is a block diagram depicting a fulfillment component in accordance with at least one embodiment of the present invention; and

FIG. 5 is a block diagram is a method for bridging a fiat ledger system and a distributed ledger system, in accordance with at least one embodiment of the present invention.

Like reference numerals refer to like parts throughout the several views of the drawings.

### DETAILED DESCRIPTION OF THE PREFERRED EMBODIMENT

In accordance with the foregoing, at least one embodiment of the present invention may comprise a system 10 and method 500 for electronically configuring a digital representation of a given amount of real funds for the subsequent transfer thereof. As previously stated, such a system and method may be configured for operation through a conveniently provided electronic platform, such as a mobile application or application programming interface, which may be disposed on a plurality of devices including, without limitation, a mobile phone, a laptop, a tablet, an automated teller machine, or any other computer system having a processor disposed in connection with a memory and configured to communicate with other such devices over a peer-to-peer network.

More specifically, such a system 10 and method 500 may be configured to create an electronic and/or digital representation of a promise, such as a promissory note, a debit account, a line of credit account, a credit card account, or any other type of promissory and/or trust-based relationship between at least two parties, whether comprising real funds or some other tangible or intangible object deemed representative of real funds, whether now known or hereafter developed. Such an electronic and/or digital representation may take the form of one digital token, a plurality thereof, or some positive, non-imaginary, fractional amount thereof, all of which shall be referred to herein as digital token(s), or some variation thereof, whether singular or plural. In various embodiments of the present invention, such digital token(s) may be minted by a financial institution, a federal entity, or some other third-party entity, wherein such digital token(s) may serve as representations of such real funds, and may be transferred to any pertinent third-party, ad infinitum.

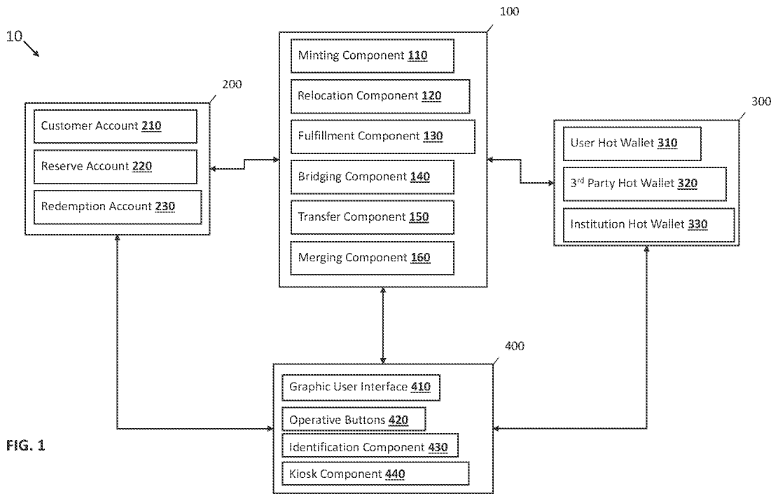

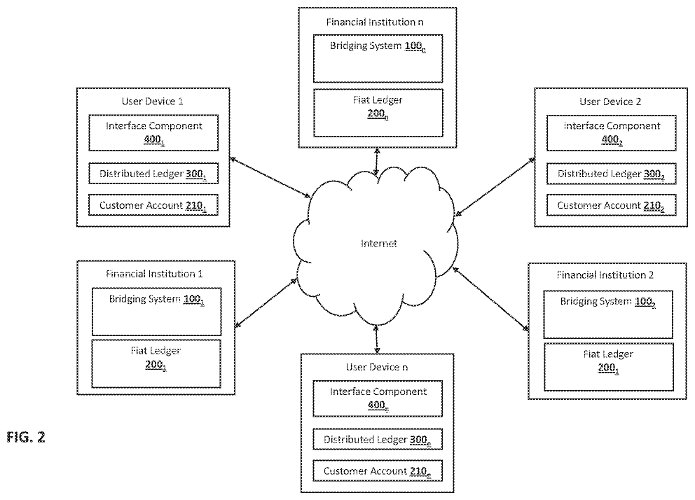

As such, at least one embodiment of the present invention, such as the one depicted in FIG. 1, may comprise a fiat ledger system 200 and a distributed ledger system 300, which may be interconnected via a bridging system 100 disposed there between. Further, such fiat ledger system 200, distributed ledger system 300, and bridging system 100, or at least certain portions thereof, may be disposed in connection with an interface component 400, which may be configured to display information to users whilst providing certain input-output operations, thereby enabling a user to at least partially control the various functionalities of the bridging system 100, the fiat ledger system 200, and the distributed ledger system 300. For instance, as illustrated in the embodiment depicted in FIG. 2, such fiat ledger system 200, distributed ledger system 300, and bridging system 100 may all be interconnected through the internet or some other peer-to-peer network through a plurality of interconnected user devices and financial institutions, each of which may have certain components disposed thereon or otherwise disposed in connection therewith. For instance, such user devices may comprise an interface component 400, which may be connected with the distributed ledger system 300 and a customer account 210. Likewise, such financial institutions may comprise the bridging system 100, the fiat ledger system 200, and the distributed ledger system 300. All such systems, ledgers, and components will be discussed in greater detail hereafter.

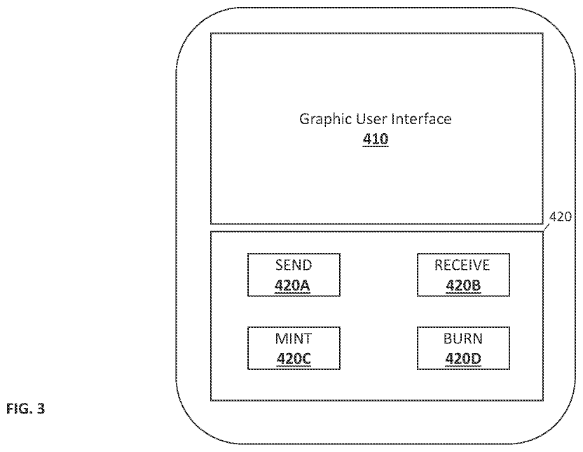

As may be seen with reference to FIG. 3, such an interface component 400, in at least one embodiment of the present invention, may comprise an application programming interface disposed on a mobile device. In such an embodiment, such interface component 400 may comprise a graphic user interface 410, and at least one operative button 420 disposed in input-output relation with at least one system and/or component of the system disclosed herein. As may be understood, such graphic user interface 410 may be configured to present information to a user of such interface component 400, such as, for instance, the user's relevant accounts, information associated therewith, and other information such as those pertaining to transactions the user recently entered into, and the going exchange rates for already circulated digital currencies, such as Ethereum and Bitcoin. With respect to the aforementioned operative button(s) 420, it may be seen at least one embodiment of the present invention may present a send button 420A, a receive button 420B, a mint button 420C, and a burn button 420D. Such operative button(s) 420 will be discussed as greater detail hereafter. As may be understood, alternative embodiments of the present invention envision alternative operative button(s) 420 as well.

Returning to FIG. 1, it may be seen at least one embodiment of the present invention may comprise a fiat ledger system 200. Such a fiat ledger system 200 may itself comprise, for instance, the various ledgers and accounts used in traditional banking systems. As such, the fiat ledger system 200 of at least one embodiment of the present invention may comprise at least one, and in most instances a plurality of customer accounts 210, as well as a general reserve account 220 of a given financial institution. Such a customer account 210 may be configured as a debit account, a line of credit account, a credit card account, or any other like medium through which real funds, or some tangible or intangible representation thereof, may be construed as a promissory or other trust-based relationship with a given financial institution.

Such a reserve account 220 may comprise, for instance, a liquid account into which a bank places deposits sufficient to fulfill the withdraw requests issued by its customers, or some other account into which a financial institution may place funds that are the subject of promises and/or trust arrangements entered into between itself and its customers. In alternative embodiments of the present invention, such reserve account 220 may additionally be comprised of multiple such reserve accounts from a plurality of member-banks, all of which may be owned by a single entity, or otherwise structured so as to be controlled via the system presented herein. Such member-banks may comprise, for instance, a plurality of financial institutions already utilizing the system disclosed herein. In so doing, it may be understood all such member-banks may be provided with access to the entirety of the funds issued under a single system. In so doing, such member banks may be afforded greater liquidity in redeeming digital tokens circulated by alternative financial institutions.

Further, such a fiat ledger system 200 may additionally comprise at least one redemption account 230, which may itself comprise the same account as the aforementioned customer account 210, or some alternative bank account for a third-party, whether at the same financial institution, at a third-party financial institution, or otherwise. Such a redemption account 230 may be construed as the account into which the funds that are the subject of the promise and/or trust arrangement represented by the digital token(s) are to be placed once such digital token(s) are redeemed, whether by the original holder and/or some other third-party end-holder.

With additional reference to FIG. 1, it may be seen at least one embodiment of the present invention may further comprise a distributed ledger system 300, which is both distinct and separate from the aforementioned fiat ledger system 200. Such a distributed ledger system 300 may comprise, for instance, any blockchain, decentralized acyclic graph, tangle, or some other cryptocurrency network, whether permissioned or permission-less, whether private or public, and whether now known or hereafter developed. Generally speaking, such a distributed ledger system 300 need only be able to operate as an electronic and/or digital ledger. Moreover, such a distributed ledger system 300 may, in at least certain embodiments, be configured to allow for the allocation of addresses or other areas under the control of entities, whether comprising an individual, an organization, or some alternative structure, such as a group of individuals, a group of organizations, or some combination thereof. As may be understood, such addresses may be used for the transfer of value, or digital representations thereof, both into and out of such addresses. Further, in at least one embodiment of the present invention, the distributed ledger system 300, and the various components thereof, may be governed by a smart contract. Likewise, it may be understood all such components of the distributed ledger system 300, such as the user hot wallet 310, the third-party hot wallet 320, and/or or the institution hot wallet 330 may, either individually or in totality, simply comprise a smart contract controlled and/or operated by the bridging system 100.

For example, such a distributed ledger system 300 may comprise, in at least one embodiment of the present invention, a user hot wallet 310. Such a user hot wallet 310 may, in at least certain embodiments, comprise a tool, such as the aforementioned address(es) which may allow a user of the present invention to receive and/or transmit digital token(s). For instance, in at least one embodiment of the present invention, such a user hot wallet 310 may be linked with various public and private keys to facilitate transactions, and to further provide security thereto. Likewise, such a user hot wallet 310 may either be connected to the internet, or may instead be configured in an offline environment, for temporary connection therewith through some alternative means. Even further, such user hot wallet 310 may be configured to be connected with a plurality of disparate accounts, such that each account a user may have may be accessed through a single user hot wallet 310. Such a distributed ledger system 300 may additionally comprise further addresses and/or hot wallets linked with alternative parties. For instance, such a distributed ledger system 300 may additionally comprise at least one third-party hot wallet 320, which may be the address for the transfers of digital tokens for some alternative third-party. Likewise, such a distributed ledger system 300 may additionally comprise at least one institution hot wallet 330, which may comprise the address for digital token transfer for a given financial institution, and may likewise comprise a plurality of distinct addresses for such financial institution. As may be understood, each such third-party hot wallet 320 and institution hot wallet 330 may comprise structure and configurations akin to the aforementioned user hot wallet 310. As stated previously, all such foregoing components of the distributed ledger system may instead simply comprise smart contracts.

Further, in at least one embodiment of the present invention, such at least one institution hot wallet 330 may be configured to be commingled with a plurality of other financial institutions. Accordingly, it may be understood a plurality of financial institutions, may utilize a single institution hot wallet, or a plurality thereof, as a repository into which the unusable digital token(s) thereof may be stored.

As previously discussed, and with reference to FIGS. 1 and 2, such fiat ledger system 200 and distributed ledger system 300 may, in at least one embodiment of the present invention, be disposed in connection with an interface component 400. Such an interface component 400 may comprise, for instance, a mobile application or some other application programming interface, which may be disposed on a plurality of devices including, without limitation, a mobile phone, a laptop, a tablet, a kiosk, an automated teller machine, or any other computer system having a processor disposed in connection with a memory and configured to communicate with other such devices over a peer-to-peer network. Accordingly, such interface component 400 may comprise, for instance, a graphic user interface 410, configured to display information to a user, disposed in connection with at least one, and in some instances a plurality, of input-output buttons 420, through which a user may operate such interface component 400. As may be understood, such input-output buttons 420 may thus be communicably configured to control at least certain portions of such fiat ledger system 200 and such distributed ledger system 300. For instance, a user may use such input-output buttons 420 of such interface component 400 to access his or her customer account 210 of the fiat ledger system 200, or to control digital token transfer into and out of the user hot wallet 310 of the distributed ledger system 300.

As previously stated, and with further reference to FIG. 1, it may be seen at least one embodiment of the present invention may comprise a bridging system 100 disposed in connection with the aforementioned fiat ledger system 200, distributed ledger system 300, and the interface component 400. Generally speaking, such a bridging system 100 may be interlinked with such alternative systems, ledgers, and components such that a user may form a promise and/or trust arrangement with a financial institution, receive a digital representation of such promise and/or trust arrangement through digital token(s), and transfer such digital token(s) ad infinitum, all whilst all such transactions are bridged between the fiat ledger system 200 and the distributed ledger system 300 via at least one entry, and in many instances a series of entries, disposed on the appropriate accounts of each such ledger system. Alternatively put, such a bridging system 100 may comprise various components configured to mint or otherwise provide already minted digital token(s) for an amount of funds represented by a promise and/or trust arrangement between a user and a pertinent financial institution.

For instance, with continued reference to FIG. 1, it may be seen such a bridging system 100 may comprise a minting component 110. Such a minting component 110 may be configured to effectuate the transformation of a given amount of real funds represented by a promise and/or other trust-based relationship into an electronic representation thereof, such as a digital token. As previously stated, while referred to herein as a minting component 110, it should be understood such minting component 110 need not necessarily effectuate the actual minting of such digital token(s). Rather, such minting component 110 may, in alternative embodiments, mint digital token(s), or alternatively circulate already minted digital token(s), no matter the source thereof.

For instance, one embodiment of such a minting component 110 may be configured to actually mint, or otherwise create and/or generate digital token(s) upon the effectuation of a promissory and/or trust-based relationship between a financial institution and its customer. In such an instance, such digital token(s) may be considered both generated and minted by the pertinent financial institution, and thus may be deemed as originating specifically from such financial institution.

However, one embodiment of such a minting component 110 may instead be configured to grant to a user or customer digital token(s) minted by a federal actor, such as the Federal Reserve, or some other government-related entity of a given country. In such an instance, it may be understood one aspect of such minting component 110 may be the act of a given financial institution as circulating such digital token(s) as the last actor to do so. Accordingly, it may be understood such a minting component 110 may be configured so as to ensure such action by the financial institution is recorded. For instance, such minting component 110 may be configured to associate an at least partial degree of non-fungibility into the digital token(s) themselves when such digital token(s) are issued to the user and/or customer, thereby enabling such digital token(s) to be tracked as to their circulation origin. As may be understood, the use and/or circulation of digital token(s) minted by other entities, whether federal or otherwise, by the minting component 110 are likewise envisioned herein. Likewise, it may be understood such minting component 110 may, in at least one embodiment, be configured to utilize digital token(s) sourced in and/or from existing relationships, whether with the pertinent customer, some other third-party, or otherwise.

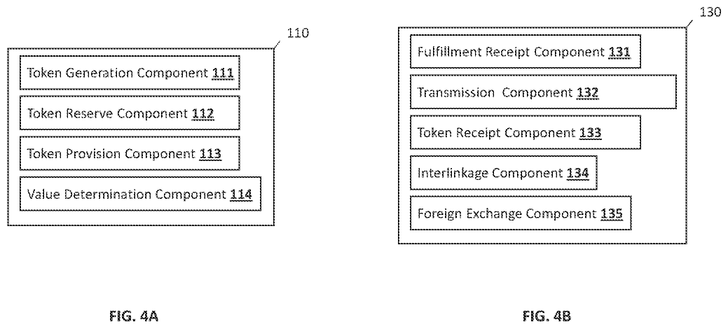

More specifically, and with reference to FIG. 4A, such a minting component 110 may itself comprise various components therein in at least one embodiment of the present invention. For instance, in one embodiment of the present invention, such a minting component 110 may comprise a token generation component 111, which may serve to actually mint, or otherwise generate digital token(s), such as in the aforementioned example. Likewise, such a minting component 110 may also comprise a token reserve component 112, into which digital token(s) are stored, whether originating from the financial institution itself, or some other third-party, whether federal or otherwise. As such, it may be understood such minting component 110 may therefore utilize digital token(s) it previously minted, and subsequently redeemed, or any other digital token(s) that may befall it. In at least one embodiment of the present invention, all such digital token(s) generated or otherwise utilized by such minting component 110 may be ERC-20 compliant; however, alternative compliances are envisioned herein, whether now known or hereafter developed. As may be understood, such token reserve component 112 may be interlinked with the distributed ledger system 300, and more particularly the at least one institutional hot wallet 330 thereof, to read the quantity of digital token(s) stored therein, or otherwise obtain and direct information therefrom and thereto.

Further, in an embodiment wherein the various components of the distributed ledger system 300, such as the user hot wallet 310, the third-party wallet 320, and/or the institutional hot wallet 330 comprise a smart contract, such minting component 110 may be configured for a minting operation, wherein a transaction is broadcast to at least one of the foregoing components of the distributed ledger system 300 for the minting of at least a portion of digital token(s) directly into any of the other such components of the distributed ledger system 300. In other words, such minting component 300 may be configured to broadcast a transaction into a smart contract, and directly mint an amount of digital token(s) directly into, for instance, the user hot wallet 310 and/or the third-party hot wallet 320. In the latter embodiment, it may be understood the disposition of digital token(s) into a user hot wallet 310 may thus be bypassed, with the digital token(s) being disposed directly into the third-party hot wallet 320.

In conjunction with the foregoing, such a minting component 110 may further comprise a token provision component 113. Such a token provision component 113 may be understood as comprising the means to provide such digital token(s) to the appropriate entity, such as the customer of the financial institution. Accordingly, it may be understood such a token provision component 113 may comprise systems and components configured to transfer such digital token(s) to a given user hot wallet 310.

Even further, it may be understood such minting component 110 may be configured so as to proscribe a certain amount of digital token(s) to a user dependent upon the value of real funds represented by such digital token(s). In other words, because the system of the present invention operates to digitally represent a given value through digital token(s), it may be understood such minting component 110 may, in at least certain embodiments, be configured to appropriately determine the amount of digital token(s) which should be issued to a user. As such, various embodiments of the minting component 110 of the present invention may comprise a value determination component 114, which may be configured to determine the amount of digital token(s) to issue for a certain amount real value.

In at least one embodiment of the present invention, such a value determination component 114 may be configured to determine the amount of digital token(s) to circulate via a proscribed formula. For example, the amount of digital token(s) to issue and/or circulate may be determined according to a formula, such as one wherein a predetermined constant defines the ratio of digital token(s) to a single unit of a given currency. For instance, in at least one embodiment of the present invention, the digital token(s) issued or otherwise circulated are, in effect, provided via an one-to-one collateral, thereby ensuring the value of such digital token(s) remains at least substantially constant throughout its circulation lifetime.

Further, it should be noted that in at least one embodiment of the present invention, such a minting component 110 may be configured to apply appendices to such digital token(s). Such appendices may be configured to allow for the separate and distinct appending of additional obligations and terms associated with a given promissory and/or trust-based relationship. For instance, where such a relationship stems from a credit card account, it may be understood the customer may, in response to the financial institution's initial effectuation of its end of the promise to provide the customer with such funds, may subsequently owe such financial institution such funds in return. Accordingly, it may be understood such an additional repayment obligation may be disposed in such appendices as a separate, but linked piece of information.

With further reference to FIG. 1, it may be seen at least one embodiment of the bridging system 100 of the present invention may further comprise a relocation component 120. Such a relocation component 120 may be configured to relocate the funds that are the subject of the promissory and/or trust-based relationship between the financial institution and the customer pursuant to the circulation of digital token(s) therefor. In other words, such a relocation component 120 may operate subsequent to, or in conjunction with, the formation of a digital representation of such a relationship between the pertinent two parties, and, in so doing, may relocate such funds to an appropriate location. For instance, in one embodiment of the present invention, the relocation component 120 may be configured to relocate the funds to the reserve account 220 of the fiat ledger system 200. Once the funds are relocated, it may be understood the financial institution is therefore in control of the funds themselves, until the digital token(s) are redeemed by the holder thereof, whether constituting the original customer herself or some other third-party.

In this sense, and as stated previously, the relocation component 120 of at least one embodiment of the present invention operates to establish the financial institution as a trustee, at least to a nominal degree, wherein the financial institution has a fiduciary responsibility over such funds. Even further, however, because the financial institution is retaining such funds within its own reserve account 220, such digital token(s) may be freely transferrable to any third-party for the subsequent redemption thereof. As such, the relocation component 120 likewise establishes a beneficiary-type denomination over the digital token(s), such that the digital token(s) serve to identify the beneficiary of the originally created promissory and/or trust-based relationship. In so doing, it may be understood the relocation component 120 therefore may operate to balance the fiat ledger system 200 and the distributed ledger system 300, while further providing for the free transfer of the digital token(s) themselves.

With continued reference to FIG. 1, it may be seen at least one embodiment of the bridging system 100 of the present invention may further comprise a fulfillment component 130. Such a fulfillment component 130 may be configured to allow the end-holder of the digital token(s) to redeem the real funds that are represented thereby. As previously stated, the end-holder of such digital token(s) may be the customer of the financial institution who was the subject of the original promise and/or trust-based relationship, or any alternative third-party. Because such fulfillment component 130 will necessarily occur after the movement of the real funds represented by such digital token(s) to the reserve account 220 of the fiat ledger system 200, it may be understood such end-holder of the digital token(s) may thus be construed as a beneficiary thereof, thereby enabling such end-holder to redeem such digital token(s) via the fulfillment component.

Referring now to FIG. 4B, it may be seen the fulfillment component 130 of at least one embodiment of the present invention may itself comprise a plurality of components configured to allow the end-user to redeem the digital token(s), or at least a portion thereof, for an equivalent amount of the real funds at issue. For instance, such fulfillment component 131 may comprise a fulfillment receipt component 131, which may be configured to receive a fulfillment request from such end-user. As such, it may be understood such fulfillment receipt component 131, and by extension the fulfillment component 130 in general, may be operatively disposed in connection with the interface component 400. More specifically, such fulfillment receipt component 131 may be configured to receive a fulfillment request via the input/output buttons 420 of the interface component. For instance, as depicted in FIG. 3, the burn button 420D provided through such interface component 400 may be configured to enable a user to issue such a fulfillment request. As may be understood, such burn button 420D may be configured so as to enable a user to issue a fulfillment request for all, or only a portion, of the digital token(s) disposed within his or her user hot wallet 310. In at least one embodiment of the present invention, such a fulfillment receipt component 131 may comprise a polling module configured to scan the system as a whole to determine when a fulfillment request has been effectuated via, for instance, the aforementioned burn button 420D. Upon effectuating such a request, it may be understood such request may be transmitted to the bridging system 100 and, more particularly, the fulfillment component thereof.

In conjunction therewith, at least one embodiment of the fulfillment component 130 may further comprise a transmission component 132, configured to effectuate the actual transfer of funds in exchange for the digital token(s). As may be understood, such transmission component 132 may thus be configured to identify the correct address for the user hot wallet 310 or the third-party hot wallet 320, dependent upon the identity of the end-holder of such digital token(s) whom issues such a fulfillment request. Once the appropriate address is identified, such transmission component 132 may thus transfer the real funds from the reserve account 220 of the fiat ledger system 200, and into either the customer account 210 or the redemption account 230.

Upon transfer of such real funds, or alternatively in conjunction therewith, the fulfillment component 130 of at least one embodiment of the present invention may utilize a token receipt component 133 to receive the digital token(s) from the end-holder, and subsequently decide what to do with such digital token(s). For instance, such token receipt component 133 may be configured to simply destroy such digital token(s), thereby deleting all electronic records associated with such digital token(s), absent those required to be maintained in the distributed ledger system 300, or, alternatively, simply add additional data to such records indicating such digital token(s) may no longer be redeemed or transferred. As may be understood, such an unusable indication may be only temporary, and may be revoked by the financial institution at a later point in time, such as through the minting component 110. Accordingly, in at least one embodiment of the present invention, such token receipt component 133 may be configured to store such unusable digital token(s) within an institution hot wallet 330, which may act as a repository for same until such digital token(s) are circulated once more.

Further, the fulfillment component 130 of at least one embodiment of the present invention may additionally comprise an interlinkage component 134. Such an interlinkage component 134 may be configured to enable disparate financial institutions operating with disparate digital token(s) to still fulfill a request for the digital token(s) of another financial institution. In other words, such interlinkage component 134 may allow a financial institution configured to solely redeem its own minted and/or circulated digital token(s) to redeem a fulfillment request from an end-holder having digital token(s) minted and/or circulated by a third-party financial institution.

More specifically, such interlinkage component 134 may be configured to enable an exchange between the digital token(s) of each disparate financial institution. For instance, such an exchange may be effectuated directly between the digital token(s) of each disparate institution themselves; or, alternatively, such exchange may instead be effectuated indirectly against an alternative type of digital currency already in circulation, such Bitcoin or Ethereum. As may be understood, because the digital token(s) at issue for each disparate financial institution are backed by real funds, the exchange rate may be readily determined therefrom, along with, for instance, certain additional variable accounting for risk variation between such financial institutions, relative accessibility of each such financial institution, the distribution of entities under such financial institution utilizing the system presented herein, or any other factor deemed pertinent to such exchange.

Even further, as may be seen with continued reference to FIG. 4B, the fulfillment component of at least one embodiment of the present invention may further comprise a foreign exchange component 135. Such a foreign exchange component 135 may be configured to enable a user having digital token(s) backed by a certain amount of real funds in one currency to effectuate an exchange with a third-party disposed in connection with a financial institution operating under a foreign currency. As such, it may be understood the foreign exchange component 135 may operate similarly to the aforementioned interlinkage component 134, wherein an exchange is provided between disparate financial institutions, or indirectly against an alternative type of digital currency already in circulation. In so doing, it may be understood foreign exchanges of currencies may be more easily effectuated.

As further depicted in FIG. 1, at least one embodiment of the present invention may further comprise a transfer component 150, which may be configured to effectuate the transfer of digital token(s), or at least a portion thereof, from the original customer to a subsequent third-party, and possibly to additional third-parties thereafter, ad infinitum. As such, it may be understood such transfer component 150 may be configured to identify the user hot wallet 310 and the applicable third-party hot wallet 320 for the effectuation of such a transfer. In so doing, it may be understood such transfer component 150 may therefore effectuate any applicable ledger entries onto such distributed ledger system 300 to effectuate such transfer.

More specifically, in at least one embodiment of the present invention, such transfer component 150 may be operatively disposed in connection with the interface component 400 to effectuate such a transfer. For instance, such transfer component 150, and the processes effectuated thereby, may be first initiated by the send button 420A, as depicted in FIG. 2. In so doing, it may be understood the customer may subsequently choose an amount of the digital token(s) to send to the applicable third-party, and effectuate such transfer. Alternatively, or in conjunction therewith, such third-party may utilize the receive button 420B to likewise initiate such a transfer. Accordingly, it may be understood the transfer of digital token(s) may, in at least one embodiment of the present invention, be manually initiated by a user through the operative button(s) 420 of the interface component 400.

In conjunction therewith, as may be seen with further reference to FIG. 1, such transfer component 150 may be configured to engage with the identification component 430 of the interface component 400. In certain embodiments, such identification component 430 may be configured to assist in the identification of the appropriate third-party hot wallet 320 to which the digital token(s) may be sent. For instance, such identification component 430 may be configured to scan a QR code affixed to a merchant's check-out counter, displayed on such third-party's device, or otherwise provided to such customer for the identification of the appropriate address for such third-party hot wallet 320. For instance, determination of the address for the third-party wallet 320 may be determined through sweeping operations performed through a sweeping module, as will be discussed in greater detail hereafter. As may be understood, alternative means of identification through such identification component 430 are envisioned herein, whether now known or hereafter developed.

In connection with the foregoing, at least one embodiment of the bridging system 100 of the present invention may, as depicted in FIG. 1, further comprise a bridging component 140. As previously stated, such bridging component may comprise various components, modules, algorithms, and the like to effectuate the foregoing functions of the bridging system 100. As such, the bridging component 140 itself may comprise a set of rules and/or instructions pertaining to the manner in which ledger entries must be made upon, for instance, the creation of a promissory and/or trust relationship, the redemption of a digital token via a fulfillment request, and thus the destruction of a certain promissory and/or trust-based relationship, and transfers of such relationship, whether comprising a transfer of the promisee of such relationship, the beneficiary of such relationship, or otherwise, via the transfer of the circulated digital token(s) themselves, or at least a portion thereof.

Alternatively put, such bridging component 140 may be configured to bridge the entries disposed on both the fiat ledger system 200 and the distributed ledger system 300 via rules and/or logic, and which may, in at least one embodiment, be stored in a cloud-based environment. Specifically, such bridging component 140 may be configured to receive the various promissory and/or trust-based relationships effectuated by the bridging system 100, and ensure the total amount of digital token(s) circulated by a given financial institution remains equal to the total amount of real funds held within the reserve account 220 of the fiat ledger system 200. In conjunction therewith, it may be understood such bridging component 140 may further be configured to determine whether additional digital token(s) need to be minted for a given promissory and/or trust-based relationship, or if the digital token(s) held within the institution hot wallet 330 and/or the token reserve component 112 are sufficient. As may be understood, such a determination may be dependent upon the total number of digital token(s) already in circulation, and may likewise factor in considerations such as any applicable minting fees of the financial institution, or any other expenses associated therewith. Such bridging component 140 shall be discussed in greater detail hereafter via exemplary rules and logic according to the particular circumstances at issue within the system presented herein. As may be understood, such rules and/or logic, the circumstances necessitating such rules and/or logic, and the results following therefrom are all merely exemplary, as a plurality of alternative circumstances, rules and/or logic, and the results stemming therefrom, are envisioned herein.

A. The Promissory Relationship Established Between the Financial Institution and its Customer Comprises a Debit Account, Wherein the Customer Transfers the Circulated Digital Tokens to a Third-Party Entity Having the Same Financial Institution.

In an embodiment of the present invention wherein the promissory and/or trust-based relationship established between a given financial institution and its customer takes the form of a debit account, it may be understood such promissory relationship may be construed as a simple promise by the financial institution to pay the funds disposed within such debit account upon demand by the customer. As such, in this example, when a customer involves the minting component 110 via, for instance, engagement with the minting button 420C, the customer's financial institution will effectuate such digital representation of the amount of funds within the debit account the customer wishes to mint by circulating at least some amount of digital token(s). In so doing, the relocation component 120 will transfer such amount of funds from the customer account 210, in this case a debit account, into the reserve account 220. Likewise, the relocation component 120 will effectuate a series of ledger entries on the fiat ledger system 200, and the distributed ledger system 300, such as in the user hot wallet 310, to render the customer in control of the digital token(s). Such series of ledger entries are governed and directed by the bridging component 140. Further, it should be noted the term “series of ledger entries,” as used throughout this disclosure, may comprise one ledger entry in total, one ledger entry in each pertinent ledger, or a plurality of ledger entries in each pertinent ledger.

Subsequently, it may be understood the customer may then transfer such digital token(s), or at least a portion thereof, to a third-party who, in this case, also uses the customer's financial institution. Here, such transfer component 150 effectuates the transfer of such digital token(s) from the user hot wallet 310 to the third-party hot wallet 320. Once again, a series of ledger entries are effectuated on the distributed ledger system 300, wherein such series of ledger entries are directed and governed by the bridging component 140.

Then, it may be understood such third-party is now the end-holder of such digital token(s) whom subsequently effectuates a fulfillment request via the burn button 420D. Such fulfillment component 130 thereby effectuates such redemption of the digital token(s), either destroying or rendering unusable the same and subsequently placing same within the institution hot wallet 330, and transferring the funds, or at least a portion thereof, from the reserve account 220 and into the redemption account 230. Once again, a further series of ledger entries are effectuated on the fiat ledger system 200 and the distributed ledger system 300 via the bridging component 140. And because the original promissory and/or trust-based relationship between the financial institution and the customer comprised a debit account, wherein the customer was already the owner of such funds, it may be understood no further obligations exists, and the bridging component 140 may thereby render the present promissory and/or trust-based relationship as terminated.

B. The Promissory Relationship Established Between the Financial Institution and its Customer Comprises a Credit Card Account, Wherein the Customer Transfers the Circulated Digital Tokens to a Third-Party Entity Having the Same Financial Institution.

The present example comprises a series of steps and rules much like the foregoing example. Indeed, the steps for the minting of digital token(s), the transfer of same, and the fulfillment of same all follow the same procedures, with a similar series of ledger entries directed by the bridging component 140 associated therewith. However, because the present promissory and/or trust-based relationship comprises a credit card account, as opposed to a debit account, it may be understood such bridging component 140 now directs some additional processes.

Specifically, as may be understood, because a customer having a credit card account is borrowing such funds when effectuating a transaction with such credit card account, it may be understood such customer must pay back the financial institution. As such, when the digital token(s) are minted by the minting component 110, the bridging component 140 directs the same to further create an appendix to such digital token(s), wherein such appendix functions to proscribe additional obligations associated with such promissory and/or trust-based relationship. Here, such additional obligations comprise the obligation of the customer to repay the funds to the financial institution. Thus, when the fulfillment component 130 effectuates the redemption of the funds to the applicable third-party by transferring the funds from the reserve account 220 to the redemption account 230, and subsequently destroys or otherwise renders such digital token(s) as unusable, the appendix thereto shall remain. In such instance, the bridging component 140 thus directs an additional series of ledger entries denoting an additional obligation remains, namely, that of the customer to repay the financial institution. Once repayment is received, such as through the fulfillment component 130, such bridging component 140 may subsequently direct the destruction of such obligation, and thereby render the present promissory and/or trust-based relationship as fulfilled.

As such, in the present example, it may be seen the initial promissory and/or trust-based relationship between the financial institution and the customer thereof may be treated as a real value at the moment such relationship is effectuated, without the need to wait for settlement, because the real funds that are the subject of such relationship are retained within the reserve account 220 of the fiat ledger system 200. As such, it may be understood the fees associated with the clearing house operations of traditional credit card transactions may be effectively reduced, or otherwise eliminated.

C. The Promissory Relationship Established Between the Financial Institution and its Customer Comprises a Line of Credit Account, Wherein the Customer Seeks to Transfer the Circulated Digital Tokens to a Third-Party Entity Having the Same Financial Institution.

Much like the foregoing examples, the present example similarly operates to effectuate the promissory and/or trust-based relationship via the circulation of digital token(s), for the subsequent redemption thereof. However, unlike the foregoing examples, the bridging component 140 here may instead direct the elements of the bridging system 100 to instead send the digital token(s) directly to the pertinent third-party, thereby disposing such digital token(s) directly into the third-party hot wallet 320.

As such, the bridging component 140 in this example may therefore bypass the user hot wallet 310, and thus may only issue a series of ledger entries sufficient to balance the fiat ledger system 200 and the distributed ledger system 300 in its current state. As may be understood, such bypass may be enabled by, for instance, the transfer component 150 of the bridging system 100, and its interaction with the identification component 430 of the interface component 400, such as through the use of a QR code or some other informational means.

With additional reference to FIG. 1, it may be seen the bridging system 100 of at least one embodiment of the present invention may additionally comprise a merging component 160. Such a merging component 160 may be configured to merge two disparate and distinct sets of digital token(s). For instance, such merging component 160 may be utilized in the event two distinct financial institutions agree to a merger. In such case, it may be understood such two distinct financial institutions may have two distinct digital token(s) currently in circulation. Accordingly, the merging component 160 of the present invention may operate to merge such distinct digital token(s) into a single unitary digital token(s), without any loss or float to the consumers of such financial institutions.

More specifically, such a merging component 160 may merge such two distinct digital tokens into a single form of digital tokens via a constant proportion and/or ratio, whilst retaining the real funds disposed in each financial institutions' reserve account 220 with each such financial institution. Accordingly, because the real funds remain disposed within the reserve account 220 of each such financial institution, without any intermingling thereof, it may be understood financial institutions operating under different fiat currencies may easily effectuate a merger, and thereby create a single form of a digital token acceptable in both such fiat currencies. Accordingly, such merging component 160 may assist in the effectuation of the creation of a single form of world currency in a passive, decentralized manner, as disparate financial entities may form mergers at their will. Through the effectuation of enough such mergers, it may be understood the digital token(s) on offer through the entirety of the globe's financial institution may thus shrink, thereby slowly, but consistently, enabling all financial institutions to creep towards a single digital token whilst preparing for same.

As seen with further reference to FIG. 1, the interface component 400 of at least one embodiment of the present invention may additionally comprise a system configured to enable the forgoing processes of the system described herein through kiosk component 430, which may comprise, for instance, an automated teller machine. In such an embodiment, any of the foregoing processes, including, without limitation, the process for minting a certain amount of digital token(s) may be effectuated via a customer's interaction with a kiosk component 430, or some other like kiosk, system, component, or device configured to provide similar capabilities to a customer of a financial institution, whether now known or hereafter developed.

Akin to one embodiment of the transfer component 150 previously discussed herein, such kiosk component 430 may likewise be configured to utilize the interface component 400 of at least one embodiment of the present invention, which may be disposed thereon. Specifically, in addition to a graphic user interface 410 and operative button(s) 420 disposed on such a kiosk component 440, such kiosk component 440 may further be configured to utilize an identification component 430 to identify the relevant address for the user hot wallet 310. For instance, such kiosk component 440 may utilize a QR code, or any other like component, to perform such identification processes, wherein such identification processes may be effectuated via a sweeping module.

More specifically, in at least one embodiment of the present invention, such kiosk component 440 may operate as follows: (1) a user of such kiosk component 440 specifies a requested amount of digital token(s); (2) the bridging system mints or otherwise circulates already-minted digital token(s) to some other distinct bank-controlled address on such distributed ledger system 400, such as an institution hot wallet 330′; (3) the private key for such institution hot wallet 330′ is presented on the kiosk component 440 via the identification component 430, wherein such identification component 430 comprises a QR code; (4) the customer uses his or her own interface component 400 to identify the appropriate address via the QR code using sweeping processes, wherein the customer subsequently receives such digital token(s) into his or her own user hot wallet 310; and (5) in conjunction therewith, the bridging component 140 enters a series of ledger entries to lower the balance in the customer account 210 of the fiat ledger system 200; or (6) the kiosk component 440 cancels the transaction in the event the aforementioned identification component 430 does not effectuate an identification of the pertinent addresses within a specified timeframe, and the digital token(s) are returned to a secure institution hot wallet 330″.

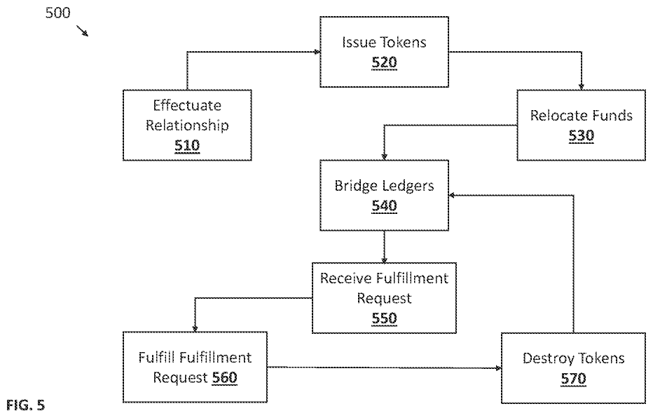

In view of the foregoing, a method can be generally proscribed for at least one embodiment of the invention disclosed herein. Specifically, such a method may comprise the one depicted in FIG. 5, wherein such method may comprise the following steps: (1) the effectuation of a promissory and/or trust-based relationship 510; (2) the issuance of some amount of digital token(s) to represent such relationship 520; (3) the relocation of the real funds from the customer account 210 to the reserve account 220; (4) the bridging of the fiat ledger system 200 and the distributed ledger system 300 via the bridging system 100, and the various components thereof 540; (5) the receipt of a fulfillment request from the end-holder of at least some amount of such digital token(s) 550; the fulfillment of such fulfillment request through the fulfillment component 130 and the other components associated therewith 560; (6) the destruction of the digital token(s), or the rendering thereof as unusable 570; and (7) the bridging of the fiat ledger system 200 and the distributed ledger system 300 via the bridging system 100, and the various components thereof 540.

As may be seen in the foregoing, at least one embodiment of the foregoing system described herein may comprise certain advantages and/or incentives, for both the financial institution itself and the customers thereof. For instance, because the funds that are the subject of the promissory and/or trust-based relationship are retained at the financial institution, such financial institution therefore gets to retain the float and/or collateral of same while such digital token(s) are in circulation. Likewise, because system reduces or otherwise eliminates the need for clearinghouse operations, banks need not share fees with such entities, thereby enabling such banks to charge smaller fees for minting procedures, and other processes recited herein. Likewise, the ability to easily merge disparate digital token(s) of distinct financial institutions, or to otherwise easily and efficiently exchange such digital token(s) through a directly with other financial institutions, or indirectly with alternative digital currencies already in circulation, provides advantages for customers requiring the foreign exchange of currencies.

What is claimed is:

1. A system for providing customers of a financial institution with a freely transferable digital representation of value, said system comprising:
a fiat ledger system controlled by at least one financial institution, said fiat ledger system comprising at least one customer account and at least one reserve account;
a distributed ledger system configured to operate in connection with a cryptocurrency network, said distributed ledger system comprising at least one user hot wallet;
said fiat ledger system disposed in connection with said distributed ledger system via a bridging system, said bridging system comprising:
a minting component configured to circulate a digital representation from an amount of value disposed within said at least one customer account, said digital representation stored within said at least one user hot wallet;
a relocation component configured to relocate said amount of value from said at least one customer account to said at least one reserve account;
a fulfillment component configured to redeem said amount of value from said digital representation to an end-holder of said digital representation; and
a bridging component configured to ensure the total amount of value disposed within said fiat ledger system is equivalent to the total amount of value represented in said distributed ledger system.

2. The system of claim 1, wherein said fiat ledger system further comprises a redemption account.

3. The system of claim 2, wherein said distributed ledger system further comprises a third-party hot wallet, and said bridging system further comprises a transfer component configured to enable the transfer of said digital representation from said at least one user hot wallet to said at least one third-party hot wallet.

4. The system of claim 3, said end-holder of said digital representation comprises a third-party associated with said redemption account, such that said fulfillment component redeems said amount of value from said digital representation into said redemption account.

5. The system of claim 3, wherein said minting component is configured to bypass said user hot wallet and store said digital representation directly into said third-party hot wallet through the use of a smart contract disposed on said distributed ledger system.

6. The system of claim 1, wherein said amount of value remains within said reserve account until said fulfillment component redeems said amount of value from said digital representation to an end-holder.

7. The system of claim 1, wherein said digital representation comprises a positive, non-imaginary amount of digital tokens.

8. The system of claim 7, said distributed ledger system further comprising an institution hot wallet, said institution hot wallet storing a plurality of digital tokens currently rendered unusable by said bridging system.

9. The system of claim 8, wherein said minting component is further configured to restore at least a portion of said plurality of digital tokens currently rendered unusable by said bridging system and subsequently dispose same within said customer account.

10. The system of claim 1, wherein said bridging component is configured to effectuate a series of ledger entries in said fiat ledger system, and a series of entries in said distributed ledger system.

11. A system for providing customers of a financial institution with a freely transferable digital representation of value, said system comprising:
a fiat ledger system controlled by at least one financial institution, said fiat ledger system comprising at least one customer account, at least one reserve account, and at least one redemption account;
a distributed ledger system distinct from said fiat ledger system, said distributed ledger system comprising at least one user hot wallet and at least one third-party hot wallet;
said fiat ledger system disposed in connection with said distributed ledger system via a bridging system disposed there between;
an interface component configured on a mobile device for input-output communication with said fiat ledger system and said distributed ledger system via said bridging system;
said bridging system comprising:
a minting component configured to circulate a digital representation of an amount of value, said amount of value comprising a promissory relationship between a financial institution and a customer thereof as effectuated and stored through said at least one customer account, and said digital representation comprising an amount of digital tokens circulated into said at least one user hot wallet;
a relocation component configured to transfer said amount of value from said at least one customer account to said at least one reserve account;
a transfer component configured to enable the transfer of at least a portion of said amount of digital tokens from said at least one user hot wallet to said at least one third-party hot wallet through the identification of an user address associated with said at least one user hot wallet and a third-party address associated with said at least one third-party hot wallet;
a fulfillment component configured to transfer said amount of value from said at least one reserve account to said at least one redemption account upon receipt of a fulfillment request from an end-holder of said at least a portion of said amount of digital tokens; and
a bridging component configured to establish a bridge between said fiat ledger system and said distributed ledger system via the effectuation of a series of ledger entries in each of said fiat ledger system and said distributed ledger system.

12. The system of claim 11, wherein said amount of digital tokens comprises a positive, non-imaginary number.

13. The system of claim 11, wherein said end-holder comprises a secondary third-party associated with at least one secondary third-party wallet disposed on such distributed ledger system.

14. The system of claim 11, wherein said minting component is configured to mint said digital representation prior to the circulation thereof.

15. The system of claim 11, said distributed ledger system further comprising an institution hot wallet configured to store a plurality of unusable digital tokens therein.

16. The system of claim 14, wherein said minting component is configured to circulate at least a portion of said plurality of unusable digital tokens disposed within said institution hot wallet after rendering same usable.

17. The system of claim 11, wherein said interface component comprises an identification component configured to assist said transfer component in identifying said user address associated with said at least one user hot wallet address and said third-party address associated with said at least one third-party hot wallet via a QR code.

18. The system of claim 17, wherein said interface component further comprises a kiosk component having said identification component disposed thereon.

19. The system of claim 11, wherein said bridging system further comprises a merging component configured to merge said digital tokens of said at least one financial institution with third-party digital tokens circulated by at least one third-party financial institution, thereby forming unitary digital tokens.

20. The system of claim 11, wherein said fulfillment component is configured to enable an exchange between said amount of digital tokens and a third-party financial institution who did not circulate said amount of digital tokens.

21. The system of claim 11, wherein said at least one reserve account is accessible by said financial institution and at least one alternative financial institution.

22. A method for providing customers of a bank with a freely transferable digital representation of value, the method comprising:
establishing a promise between a bank, as promisor, and a customer, as promisee, the promise comprising an amount of value;
disposing the promise within a fiat ledger system controlled by the bank, the fiat ledger system comprising at least one customer account and at least one reserve account;
linking the fiat ledger system with a distributed ledger system, the distributed ledger system comprising at least one customer wallet;
creating a digital representation of the amount of value of the promise, the digital representation disposed within the at least one customer wallet;
relocating the amount of value from the at least one customer account to the at least one reserve account;
receiving a fulfillment request from an end-holder of the digital representation;
fulfilling the fulfillment request by:
transferring the amount of value from the reserve account to the end-holder;
destroying the digital representation; and
continuously bridging the fiat ledger system and the distributed ledger system to ensure the total amount of value disposed within the fiat ledger system is equivalent to the total amount of value represented in the distributed ledger system.

23. The method of claim 22, wherein the digital representation comprises a positive, non-imaginary number of digital tokens.

24. The method of claim 22, wherein the reserve account is accessible by the bank and at least one alternative bank.

25. The method of claim 22, wherein the digital representation comprises an appendix configured to store at least one additional obligation of the promise.

26. The method of claim 22, wherein the end-holder comprises a third-party having a redemption account into which the amount of value is transferred.
